(19) United States
(12) Patent Application Publication
(10) Pub. No.: US 2025/0030782 A1
(43) Pub. Date: Jan. 23, 2025

(54) STATE-BASED TIMESLOTS AND SYSTEMS FOR DATA USAGE RECORDING AND PUBLISHING

(71) Applicant: VMware LLC, Palo Alto, CA (US)

(72) Inventors: Bo LIN, Beijing (CN); Kai LOU, Beijing (CN); Chuntao CHEN, Beijing (CN); Caixia JIANG, Beijing (CN); Xi ZENG, Beijing (CN); Wu QI, Beijing (CN); Danyang LI, Beijing (CN); Xiao LIANG, Beijing (CN)

(21) Appl. No.: 18/477,052

(22) Filed: Sep. 28, 2023

(30) Foreign Application Priority Data
Jul. 18, 2023 (WO) PCT/CN2023/107840

(51) Int. Cl. H04L 67/75

(52) U.S. Cl. CPC H04L 67/75

(57) ABSTRACT

Data usage by networking and data processing services is measured using a timeslot system. The timeslots have multiple states for collecting, collecting with processing, and expired timeslots. Data from upstream components is reported to local manager clusters and placed into timeslots corresponding to a timestamp of the data. Data can be reported from local managers to an entitlement service and/or a cloud service portal. Timing inconsistencies due to latency or processing time can be resolved by accounting for a timestamp difference using a timestamp difference value between the timeslot time and the reporting time. Data can be deduplicated, cleaned, and/or compacted. Data can be also be version controlled, with timeslots maintaining a version number. Complete and accurate tracking of data usage and associated costs is improved by reporting and collecting usage data using state-based timeslots.

### CROSS-REFERENCE TO RELATED APPLICATIONS

This application claims priority to International Patent Application No. PCT/CN/2023/107840, filed Jul. 18, 2023, entitled “STATE-BASED TIMESLOTS AND SYSTEMS FOR DATA USAGE RECORDING AND PUBLISHING”, and assigned to the assignee hereof, the contents of each of which are hereby incorporated by reference in its entirety.

### BACKGROUND

In the field of software licensing, clients generally purchase a key or subscription to access paid software services. Many existing software-defined networking solutions, for example, use a subscription based model. However, such models do not measure actual cost or usage of the service. For many software services it may be difficult to measure actual usage, so a key or subscription is used as a simplified compensation scheme for usage of the services.

In various situations, software-defined network services are deployed in various computing environments and provide many benefits, but attempting to closely monitor actual data usage of such services presents many problems, such as the possibilities of duplicate data reporting, incomplete data reporting, time inconsistency, and challenges related to how to store and process the data. Therefore, there is a need for solutions that ensure deduplication and reliable transmission of data with accurate data usage monitoring, with acceptable levels of performance, availability, scalability, latency, etc.

It should be noted that the information included in the Background section herein is simply meant to provide a reference for the discussion of certain embodiments in the Detailed Description. None of the information included in this Background should be considered as an admission of prior art.

### SUMMARY

Aspects of the present disclosure introduce state-based timeslots for data usage recording and publishing. In embodiments, a computing system can perform a method of receiving a stream of data including data usage information from one or more components at a local manager cluster; generating, at the local manager cluster, one or more timeslot boxes, wherein each timeslot box of the timeslot boxes comprises a time range, a timeslot box version number, and a timeslot box state; dividing the stream of data into the one or more timeslot boxes based on one or more timeslot values and one or more timeslot difference values for the stream of data; reporting, by the local manager cluster to an entitlement service, the stream of data divided into the one or more timeslot boxes based on corresponding timeslot box states of the timeslot boxes; processing, by the entitlement service, the stream of data divided into the one or more timeslot boxes to determine processed data usage information; and reporting the processed data usage information

According to various embodiments, a non-transitory computer-readable medium comprising instructions is disclosed herein. The instructions, when executed by one or more processors of a computing system, cause the computing system to perform operations for receiving a stream of data including data usage information from one or more components at a local manager cluster; generating, at the local manager cluster, one or more timeslot boxes, wherein each timeslot box of the timeslot boxes comprises a time range, a timeslot box version number, and a timeslot box state; dividing the stream of data into the one or more timeslot boxes based on one or more timeslot values and one or more timeslot difference values for the stream of data; reporting, by the local manager cluster to an entitlement service, the stream of data divided into the one or more timeslot boxes based on corresponding timeslot box states of the timeslot boxes; processing, by the entitlement service, the stream of data divided into the one or more timeslot boxes to determine processed data usage information; and reporting the processed data usage information.

According to various embodiments, a system comprising one or more processors; and at least one memory is disclosed herein. The one or more processors and the at least one memory are configured to cause the system to: receive a stream of data including data usage information from one or more components at a local manager cluster; generate, at the local manager cluster, one or more timeslot boxes, wherein each timeslot box of the timeslot boxes comprises a time range, a timeslot box version number, and a timeslot box state; divide the stream of data into the one or more timeslot boxes based on one or more timeslot values and one or more timeslot difference values for the stream of data; report, by the local manager cluster to an entitlement service, the stream of data divided into the one or more timeslot boxes based on corresponding timeslot box states of the timeslot boxes; process, by the entitlement service, the stream of data divided into the one or more timeslot boxes to determine processed data usage information; and report the processed data usage information.

### BRIEF DESCRIPTION OF THE DRAWINGS

FIG. 1 is a schematic diagram of a system of data usage recording and publishing for a cloud service, according to embodiments.

FIG. 2 is a schematic diagram of a timeslot system of data usage recording and publishing, according to embodiments.

FIG. 3 is a schematic diagram of a system of data usage recording and publishing for a cloud service using timeslots, according to embodiments.

FIG. 4 is a schematic diagram illustrating states of a timeslot, according to embodiments.

FIG. 5 is a schematic diagram illustrating version control for a timeslot based system of data usage recording and publishing, according to embodiments.

FIG. 6 is a schematic diagram illustrating data compacting for a timeslot based system of data usage recording and publishing, according to embodiments.

FIG. 7 illustrates a data collecting workflow, according to embodiments.

FIG. 8 illustrates a data processing workflow, according to embodiments.

FIG. 9 illustrates a data cleaning workflow, according to embodiments.

FIG. 10 illustrates a data cleaning workflow, according to embodiments.

FIG. 11 illustrates data collection workflow from a local manager, according to embodiments.

FIG. 12 is a flowchart of a method for reporting data usage information for a computing system, according to embodiments.

### DETAILED DESCRIPTION

Embodiments described herein involve improved data usage information storage, transmission, and processing techniques that overcome deficiencies of conventional methods.

### Definition of Terms

Entitlement service: a service that may collect pricing metric data, such as a service that collects data usage and/or pricing metric data for determining cost.

Local manager (“LM”): a management service for a local computing environment or for local computer environments that collects all local components' metric data and makes the metric data available, for example to an entitlement service.

Data: unless stated otherwise “data” as used herein may refer to pricing metric data usage data. The data can be a single item or batches of data including multiple items.

Component: various components can include a local manager, a virtual machine console, a remote console, a software defined data center (“SDDC”), cloud, and/or other cloud infrastructure components.

Verticals/vertical nodes: transport nodes of an LM including edge nodes and host nodes.

Timestamp: in various embodiments, a timestamp can be a coordinated universal time (“UTC”) time in milliseconds, or other denomination.

Timeslot: a time range that is generally indicated by a start timestamp and, in some embodiments, an end timestamp. For example, if the time range is an hour, a day can include twenty-four timeslots.

Data timeslot: the timeslot in which data is generated. For example, if data is generated at 2022/08/04 1:01:01, the data timeslot would be 2022/08/04 1:00:00 if the time range is an hour.

Timeslot box: a component for storing data in association with an indication of a timeslot. A timeslot box generally includes a timeslot value that indicates a timeslot, and can be used to store data related to that timeslot.

Downstream: where data is collected from. From the perspective of an entitlement service, components of a cloud infrastructure can be considered downstream. Further, the entitlement service may be considered downstream from a data stream processing platform or engine.

Upstream: where data is to be reported to. From the perspective of a local manager, verticals are downstream, while the entitlement service is upstream.

In general, data usage information in data streaming and/or data processing systems is used as a billing metric for determining cost of the service. The timeslot system of various embodiments includes timeslots having states relating to the status of data processed within the boundaries or adjusted boundaries of the timeslot.

As opposed to traditional data reporting, the state-based timeslots described herein can be used in conjunction with deduplication of the data and ensure increased reliability of data transmission and/or accurate data usage for certain systems. This is enabled by at least the following features.

Data flow is divided into timeslot boxes for collecting data. Each incoming data item can be allocated a timeslot box based on the data's timeslot. Each incoming data item has a timestamp value corresponding to a timeslot, timeslot value, or time range. In various embodiments, this value can be indicated in the data or calculated by the data's timestamp. Data in the timeslot box in some embodiments is versioned for deduplication and incremental update support. Timeslots may, for example, have three states: collecting, collecting with process, and expired. These states enable, for example, effective data cleaning and/or resuming data processing after a crash.

In some embodiments, to resolve time inconsistency issues between components and local managers, a timeslot difference value can be stored in the timeslot box for the various data elements. In some cases, the timestamp of the data element is adjusted by the difference value to determine the corresponding time slot such that the entitlement service can process data elements in a time-agnostic manner.

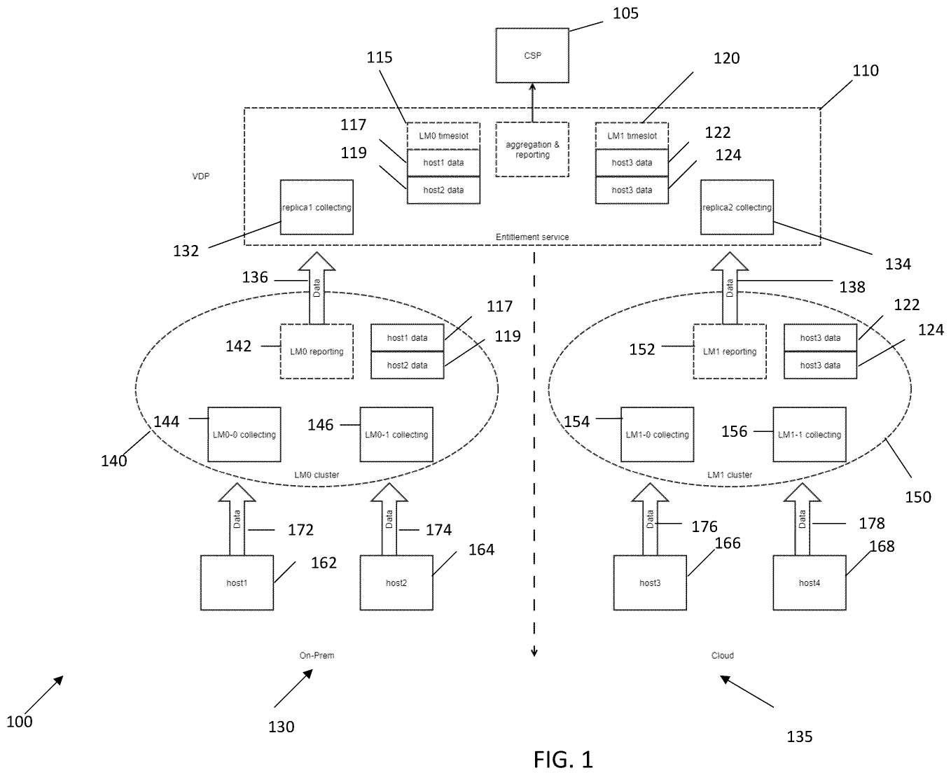

FIG. 1 is a schematic diagram of a system of data usage recording and publishing for a cloud service, according to embodiments.

In FIG. 1, a system 100 includes a cloud service portal 105. The cloud service portal 105 is upstream from an entitlement service 110. The entitlement service 110 includes a plurality of timeslots. Each timeslot of the plurality of timeslots can have data from one or more hosts associated therewith. For example, a first timeslot 115 may have an index of one or zero and can include data from a first host 117 and a second host 119. A second timeslot 120 may have an index of one or zero and can include data from a third host 122 and a fourth host 124. In the embodiment shown, an aggregating and reporting module 125 aggregates and reports the data from the first timeslot 115 and the second timeslot 120.

In various embodiments, the entitlement service may collect data from an on-premises environment 130 and/or a cloud environment 135. In the example shown, a first replica 132 is used to collect on-premises data from a first data stream 136 from the on-premises environment 130, and a second replica 134 is used to collect cloud data from a second data stream 138 from the cloud environment 135.

In the example shown, the on-premises environment 130 includes a first local manager cluster 140 having a first local manager reporting module 142 reporting the data. As shown, the data from the first host 117 and the data from the second host 119 are reported by the first local manager reporting module 142. The first local manager cluster 140 includes a first local manager collecting module 144 and a second local manager collecting module 146.

In the example shown, the cloud environment 135 includes a second local manager cluster 150 having a second local manager reporting module 152 reporting the data. As shown, the data from the third host 122 and the data from the fourth host 124 are reported by the second local manager reporting module 152. The second local manager cluster 150 includes a third local manager collecting module 154 and a fourth local manager collecting module 156.

As shown in FIG. 1, a plurality of hosts 160 includes a first host 162, a second host 164, a third host 166, and a fourth host 168. The plurality of hosts 160 can have one or more local manager collecting modules associated therewith for collecting data from the host. For example, a first stream of data 172 from the first host 162 is collected by the first local manager collecting module 144, a second stream of data 174 from the second host 164 is collected by the second local manager collecting module 146, a third stream of data 176 from the third host 166 is collected by the third local manager collecting module 154, a the fourth stream of data 178 from the fourth host is collected by the fourth local manager collecting module 156.

In various embodiments, data handling occurs on host nodes 160. In some cases the nodes 160 may be edge nodes of a cluster. The data is reported periodically, or at least once per period, for example hourly, to the local manager clusters. In various embodiments, the data is stored in case of disconnection. For example, the data may be kept in a data storage or a redundant data storage. Also for example a plugin or framework can be used to store the data. A System Health Agent (“SHA”) framework, for example, can be used to store the data if connection to a local manager is terminated. The SHA framework is a distributed system health agent that can work on all components of a network virtualization and may be used for monitoring and reporting metrics upstream reliably.

The local manager is able to collect and store data from nodes at any time. Although the nodes report data hourly in some embodiments, the reporting time point can also be a different interval, or even random in some cases. For example, the reporting time in some embodiments can also be at a reporting plugin's start time and then hourly after a first reporting.

In various embodiments, duplicate data reporting or more than one data reporting within one hour is accepted and the local manager aggregates the data. In embodiments, more than one data reporting can occur within a timeslot, and the local manager can perform deduplication of the data.

To ensure accuracy in some cases, such as due to possible disconnection, process latency and/or crash of components, the local manager may not report one timeslot's data completely at once. Rather, when the local manager collects old data from nodes, it can be able to report the data to the entitlement service as an incremental update to a version of the data.

In regards to incremental updates and versioning, data deduplication, data analysis and metering debugging, the local manager in some embodiments retains old data for a period of time. Since such data sets can become large, data compacting techniques can be applied to enable quick searching and easy data handling.

In various embodiments, both new data and incremental update data are reported. A local manager may be a single local manager or may run as a cluster. As a local manager cluster, multiple local manager nodes can collect the data. In such cases it may be especially important to avoid long time lapses between collecting and reporting. Therefore, even incremental update data is reported in some cases.

Various components can report their data with versions to the entitlement service. Components such as the local manager or software defined datacenters in some embodiments require data version management. In such embodiments, a data item without a version number can be processed based on source. Data with a new version may be taken as an incremental update, while a data item with an old version may be dropped and/or responded to (e.g., with an affirmation).

Due to networking issues with the entitlement service, local managers, and nodes, there are limits to how completely usage for a time period can be reported to a cloud portal. For example, to collect data that completes processing after the time period, the entitlement service can collect the later completed data and then report the later completed data to the cloud service portal as one or more incremental updates.

The entitlement service of some embodiments manages all data of nodes from a variety of components in large scale cases. Thus, there is a need in some cases to perform data compacting as early as possible. Aggregation and deduplication can be performed based on the versioning to eliminate unneeded data. In some embodiments, there may not be a specific need to retain data. In such cases old data can be deleted, moved into elastic search, or moved into other storage for data logging and analysis.

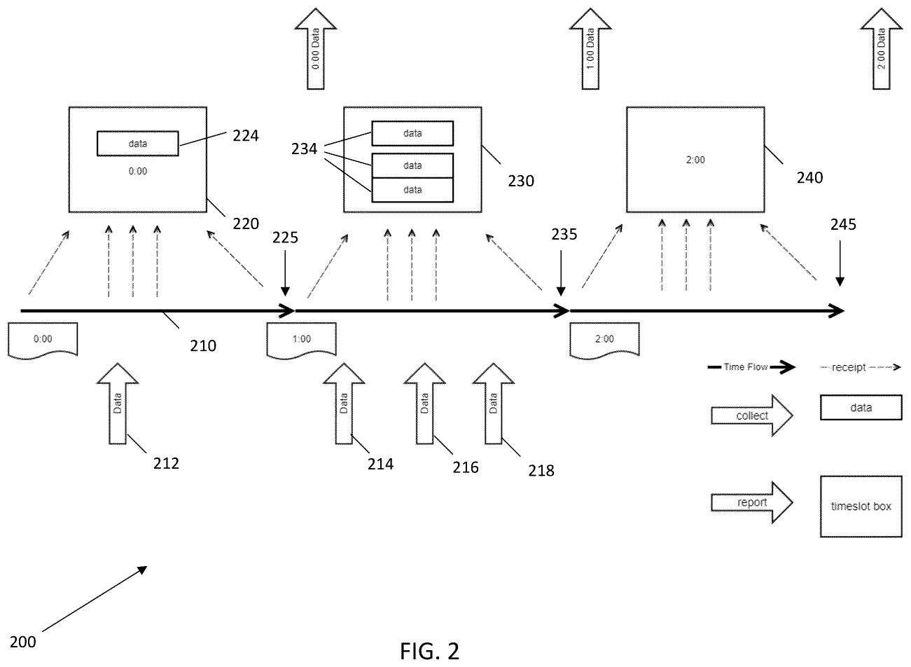

FIG. 2 is a schematic diagram of a timeslot system 200 of data usage recording and publishing, according to embodiments. As shown, data is reported at one or more instances along a timeline 210. For example, the data instances can include a first data instance 212, a second data instance 214, a third data instance 216, and a fourth data instance 218.

In the example shown, the timeline 210 is divided into a first timeslot 220, a second timeslot 230, and a third timeslot 240. A first timeslot box 222 includes a first data element 224 corresponding to the first data instance 212 and is reported at a first timeslot transition time 225 between the first timeslot 220 and the second timeslot 230. A second timeslot box 232 includes a plurality of second data elements 234 corresponding to the second data instance 214, the third data instance 216, and the fourth data instance 218 and is reported at a second timeslot transition time 235 between the second timeslot 230 and the third timeslot 240. A third timeslot box 242 includes no data and is reported at a third timeslot transition time 245 after the third timeslot 240.

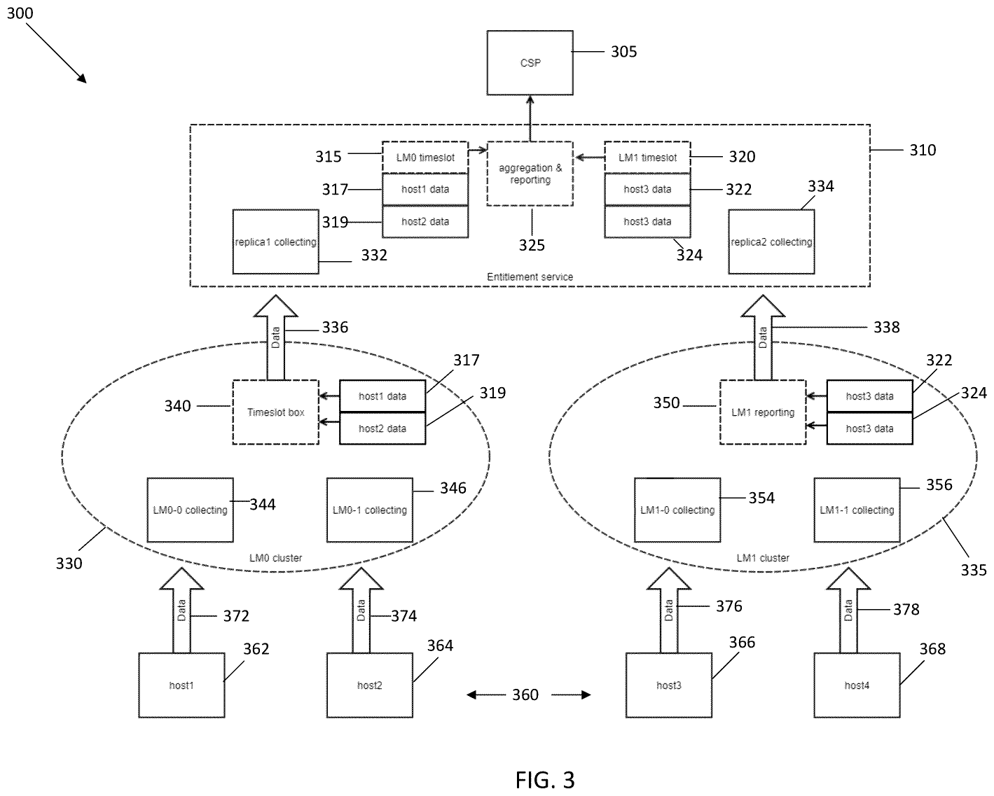

FIG. 3 is a schematic diagram of a system of data usage recording and publishing for a cloud service using timeslots, according to embodiments.

In FIG. 3, a system 300 includes a cloud service portal 305. The system 300 can be similar to the system 100 except that the host data is sorted or contained in timeslot boxes at the local manager cluster level. In the example shown the local managers report data to an entitlement service. For example, data can be reported by the local managers hourly to the entitlement service. Then the entitlement service is able to generate billing data based on pricing information and report it, for example, to a cloud portal.

From the points of view of the local manager or the entitlement service, streams of data can be both received and processed concurrently. Thus, it is difficult to tell for a given time range how much usage there may be, since the amount of remaining processing is unknown. Thus, to more efficiently handle all collected data in one time range and do reporting to upstream accurately, a designed timeslot based box is implemented.

For example, the cloud service portal 305 is configured to be upstream from an entitlement service 310. The entitlement service 310 includes a plurality of timeslots. Each timeslot of the plurality of timeslots can have data from one or more hosts associated therewith. For example, a first timeslot 315 may have an index of one or zero and can include first host data 317 and second host data 319. A second timeslot 320 may have an index of one or zero and can include third host data 322 fourth host data 324. In the embodiment shown, an aggregating and reporting module 325 accepts host data and reports host data from the first timeslot 315 and the second timeslot 320. However, the data in this case is collected by the entitlement service 310 and is reported by local manager clusters, for example of an on-premises or cloud environment, by timeslot.

In various embodiments, the entitlement service 310 may collect data from a first local manager cluster 330 and/or a second local manager cluster 335. In the example shown, a first replica 332 is used to collect data from a first data stream 336 from the first manager cluster 330, and a second replica 334 is used to collect data from a second data stream 338 from the second local manager cluster 335.

In various embodiments, synchronization can occur among entitlement replicas. In some embodiments, rough synchronization is sufficient as data is complete regardless even if reported in a later timeslot.

Regardless, in embodiments, when reporting the data, the data being reporting carries the timeslot difference value between the reporting timeslot and the data's timeslot, so that, for example, upstream nodes add this difference during a timeslot conversion, or such that the time is otherwise synchronized.

An example implementation involving a local manager reporting data to the entitlement service is as follows.

If the entitlement service is now at time 3:00 and the local manager is now at time 1:00, the local manager is two hours earlier than the entitlement service. The local manager will send ‘00:00:00’ data to the entitlement service with a timeslot difference of 1 (1:00:00-00:00:00), as the difference between the current time at the local manager and the time associated with the data is one hour. The ‘00:00:00’ data should actually be ‘2:00:00’ data from the perspective of the entitlement service. The entitlement service receives this data and associated timeslot difference, and subtracts the received timeslot difference (1) from the current time at the entitlement service (‘3:00:00’) to produce ‘2:00:00,’ which is the real timeslot for the data from the perspective of the entitlement service. In various embodiments, a timestamp can be obtained by a framework of the local manager cluster.

In certain embodiments, support for timeslot boxes at host nodes is not required. In some applications, it is not desirable for data to persist in databases on host plugins collecting data. Once the data is collected, SHA may be used to ensure that the data can be safely pushed to the local manager. For example, data carrying the generated timestamp may be sent.

One issue that must be accounted for in some cases is that if each time plugin is reporting data coincidently on the hour, a local manager may locate these reported data items into same timeslot box. For example, if a host is periodically reporting data at xx: 59:59, and 01:59:59, the data will be located into 01:00:00 timeslot box. The next data element, due to an inaccurate timer, may be 03:00:00, although it should belong to 02:00:00 timeslot box, and it will be located into 03:00:00 timeslot box, and the data on 02:00:00 will be missing. In order to work around this issue, two solutions are possible.

In one embodiment, data with a maintained timeslot value in memory is reported instead of using a timestamp of the data in the stream. In this case a plugin increases the version number by 1 every time. A host can also report data more or less frequently, such as reporting data every two hours, every half hour, or even every ten minutes. For more frequent data reporting, data transfer reliability requirements may be less restrictive.

In some embodiments, metering of data is achieved by an interface service providing communication between a software as a service platform and services for virtual machine instances in the cloud. Atlas Interface Service (AIS) is one example interface that can provide a communication channel between networking, security, and business software services and virtual machine instances, and which also includes a metrics reporting function. An AISResponse function may be included in the interface which can repeatedly report information about local manager clusters, which may be included in a ClusterInfo data element. It is anticipated that various interface services can facilitate communication between the system 300 and a pre-defined metrics reporting component to enable or improve compatibility.

In example embodiments, data of a software defined data center is pushed to the entitlement service by an event (such as a Kafka® event) every 5 minutes. Another push will not occur again if there are no data changes compared to previous data. In embodiments, the software defined data center will send the full data in single event. In some embodiments, a timestamp can be used to calculate the timeslot for the data and allocate a timeslot box automatically for the case of no data changing. In some cases, the timestamp can be used as the data version to do deduplication and full data overriding. If there is no data coming in one timeslot, this means there are no data changes and a previous timeslot box for that time period can be cloned as the present timeslot box.

In the example shown, the first local manager cluster 330 includes a timeslot box reporting module 340. As shown, the first host data 317 and the second host data 319 are reported by timeslot box module 340 to the first replica 332. The first local manager cluster 330 includes a first local manager collecting module 344 and a second local manager collecting module 346.

Due to differences in processing time for data, or due to latency of component output data, there may be a time inconsistency or lag in the data, such as a time difference between when the data element is first reported and when processing associated with the element is complete and the data usage is reported.

In various embodiments, reporting data from downstream and processing data upstream occur in parallel. For example, each time data is reported a reporting timestamp can be used accounting for a timeslot difference between the present timeslot and the data's timeslot.

In embodiments, the time of components follows a synchronization using a network time protocol. These components can be the entitlement service or a framework such as Apache® Kafka® or SHA framework. For example, once the entitlement service receives one data element in-real time, it recalculates the data's timeslot based on the timestamp from the entitlement service. For old data, when reporting the data, downstream should carry the timeslot difference between reporting timeslot and the data's timeslot, so that upstream components can utilize this difference in association with a timeslot conversion.

In the example shown, the second local manager cluster 335 includes a reporting module 335, such as a local manager reporting module or a timeslot box reporting module 350. As shown, the third host data 322 and the fourth host data 324 are reported by timeslot box module 350 to the second replica 334 via first data stream 336. The second local manager cluster 335 includes a third local manager collecting module 354 and a fourth local manager collecting module 356.

In some cases, procedure calls (for example, gRPC), can be used for reporting data, and a message is sent including the data and the timestamp on the data. In embodiments SHA framework is used and reporting and processing of data in a message queue is performed using gRPC or other remote procedure calls.

As shown in FIG. 3, the plurality of hosts 360 includes a first host 362, a second host 364, a third host 366, and a fourth host 368. The plurality of hosts 360 can have one or more local manager collecting modules associated therewith for collecting data from the host. For example, a first stream of data 372 from the first host 362 is collected by the first local manager collecting module 344, a second stream of data 374 from the second host 364 is collected by the second local manager collecting module 346, a third stream of data 376 from the third host 166 is collected by the third local manager collecting module 354, and the fourth stream of data 378 from the fourth host is collected by the fourth local manager collecting module 356.

In the example of FIG. 3, the local managers are running as a cluster and the entitlement service also is running with multiple replicas. In such embodiments, data may be collected data from distributed points. The data is reported upstream, but to ensure accuracy, data that is reported but not responded to needs to be resent. In embodiments that include data version support for deduplication and incremental update support, the data must be resent in the same manner in which it was previously sent to prevent new added data from being incorrectly taken as received. Also until reporting succeeds, the next reporting iteration is not initiated.

Thus, multiple processes running in distributed locations can collect data concurrently. For reporting, a leader may be selected and specially used for reporting data periodically. The reporting can occur hourly, or more or less often depending on the application to ensure reporting can be appropriately handled as desired.

In some embodiments, only one entitlement service replica reports data. This can be done for example by selecting a leader or by using temporal workflow. One way of implementing temporal workflow is to aggregate data into a timeslot. In some embodiments, the reporting frequency is flexible, such that data is reported daily for a previous day's data after an aggregation. The frequency to incrementally update on old data can be more or less frequent.

In various embodiments, errors can be handled without data loss. For example, even if all replicas of the entitlement service fail during reporting, the data is still maintained by the local managers until the entitlement service is restored. Other crashes may require investigation of the cloud service portal or other components of the system, but techniques described herein allow completeness of data to be maintained between components and the cloud service portal despite such transaction failure.

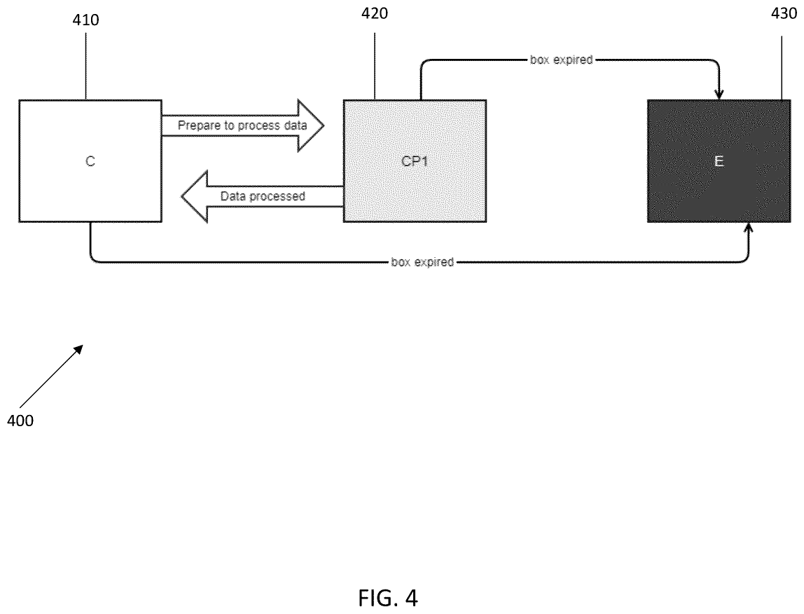

FIG. 4 is a schematic diagram illustrating states of a timeslot, according to embodiments. The state-based nature of the timeslots, in conjunction with data versioning, eases data reporting requirements while ensuring completeness, and also facilitates data cleaning and collecting.

As shown, a state diagram 400 demonstrates three possible stats of a timeslot box. In the example, a first state corresponds to a collecting state 410, a second state corresponds to a collecting with processing state 420, and a third state corresponds to an expired state 430.

In a collecting state 410, the timeslot is collecting data. However, there is no additional processing required for the data, so the data may be collected and reported. In some embodiments, a collecting state can be a default state for a timeslot.

In a collecting with processing state 420, the timeslot is collecting data. However, there is additional processing required for the data, so the data is not ready to be collected and/or reported. In some embodiments, data for the timeslot may have been prepared but processing of the data is not complete. In some cases once processing of the data is complete, the data is reported and the state can be changed back to a collecting state.

In an expired state 430, the timeslot is not collecting data, processing data, or reporting data. Since the timeslot cannot collect, process, or report data, the data of the expired slot can be bound or can be safely removed. In some cases, a timeslot may be manually set to an expired state.

In various embodiments, during state change processes from one state to another, data can be locked. For example, a lock can be placed on data tables of data stores storing the data while state changes are pending. This may prevent data from being lost or misplaced due to state changes and time inconsistency issues.

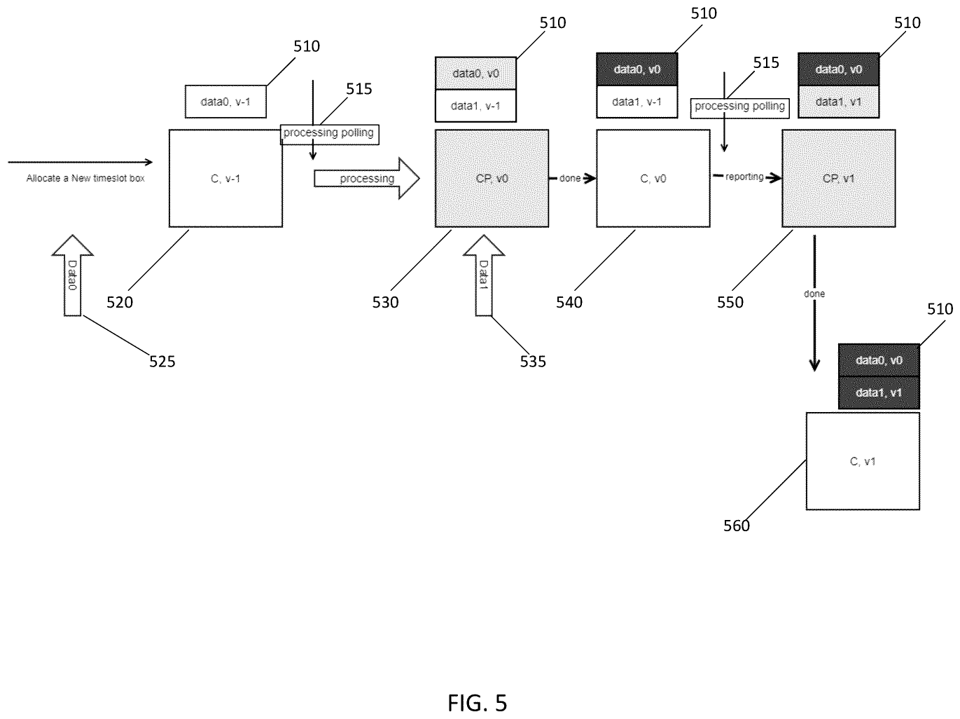

FIG. 5 is a schematic diagram illustrating version control for a timeslot based system 500 of data usage recording and publishing, according to embodiments.

As shown, the system 500 include a timeslot box 510. The timeslot box 510 may be newly allocated in some embodiments. At a first stage 520, the timeslot box 510 is in a collecting state. At stage 520, the timeslot box 510 has received a first data instance 525 and assigns the first data instance a first version number indicating the data is not yet processed.

In some embodiments, an auto increment mechanism on the data can increment the version number each time the data is written to a database. In some cases, the first version number can be −1 and can be incremented. In some cases, a create time feature of a database can be used to generate a timestamp for the data. In such cases, the data can be processed by create time order and the latest timestamp processed can be recorded.

In the example shown, the timeslot box 510 begins to process the data of the first data instance and proceeds to stage 530. For example, a processing polling function 515 is executed. At stage 530, the timeslot 510 is in a collecting with processing state. Also at stage 530, a second data instance 535 is received at the timeslot box 510. At the stage 530, the timeslot box 510 has completed processing the first data instance and stores a zero value for the version number associated the first data instance. At the stage 530, the timeslot box 510 stores the data from the second data instance with a version number value of −1.

Once processing of the data of the first data instance 525 is complete, the timeslot box 510 proceeds to stage 540. At stage 540 the timeslot box 510 is in a collecting state and the data of the first instance 525 is processed and ready to be reported with a version number of 0. The data from the second data instance 535 has not yet been processed and has a version number of −1. The version number −1 in such embodiments indicates the associated data is not yet processed.

Once processing of the data from the second data instance 535 begins, a processing polling function 515 may execute and the timeslot box proceeds to stage 550. At stage 550, the version number associated with the data of the first data instance 525 remains 0. Also at stage 550, the version number associated with the second data instance 535 is incremented to 1. In this example, the version number is incremented from −1 to 0 and from 0 to 1, although other version number increments can be used.

Once reporting and processing of the data associated with the second data instance 535 is also complete, the timeslot box 510 can proceed to stage 560. At stage 560 the timeslot box 510 in in a collecting state. The data associated with the first data instance 525 and the data associated with the second data instance 535 has been reported so the timeslot 510 can be placed in a collecting state again. New data coming in is given a version number of −1 until processed, after which they are assigned a number that is an increment of the greatest version number of the previous data instances.

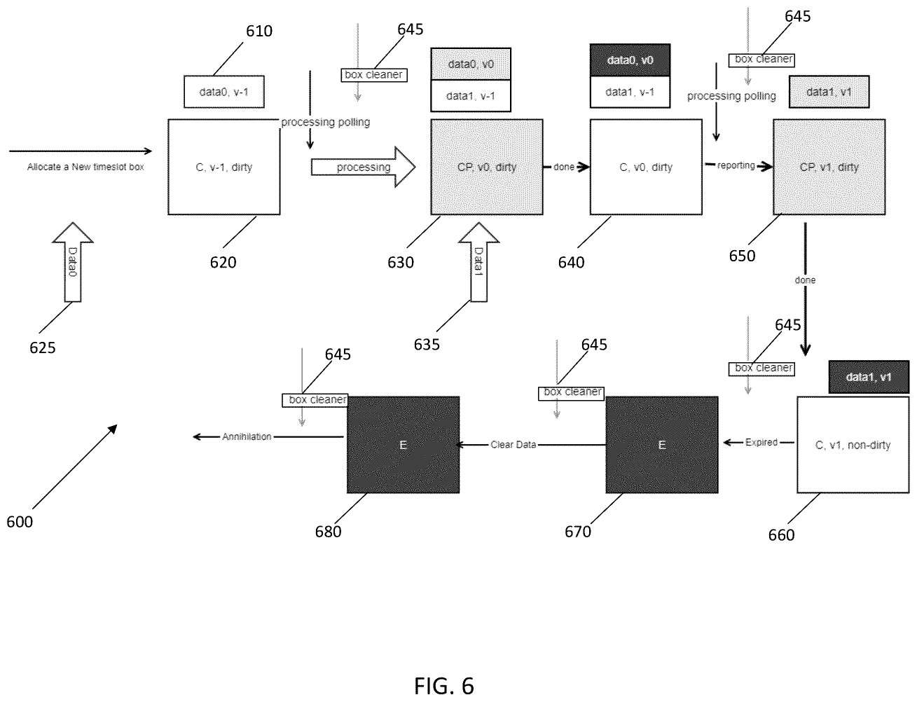

FIG. 6 is a schematic diagram illustrating data compacting for a timeslot based system 600 of data usage recording and publishing, according to embodiments. In various embodiments, the data is stored with versioning information at a database. The version numbering can enable database indexing for quick scan on the data, such as a quick scan for un-processed data having a version number of −1.

As shown, the system 600 include a timeslot box 610. The timeslot box 610 may be newly allocated in some embodiments. At a first stage 620, the timeslot box 610 is in a collecting state. At stage 620, the timeslot box 610 has received a first data instance 625 and assigns the first data instance a first version number of −1 indicating the data is not yet processed.

In various embodiments, a timeslot box cleaner runs periodically to perform a cleaning function on the data. The timeslot box cleaner removes expired data or an expired timeslot box. The frequency of the cleaning function of the timeslot box cleaner can vary. In some cases, the frequency of the cleaning function depends on a data scan and compacting requirement.

A tag or “dirty” field can be added into timeslot boxes to indicate the presence of un-processed data in the box. In such cases, a processing thread can skip a timeslot box which is not already dirty. In the example shown, the timeslot box 610 has been tagged “dirty” at stage 620 since there is unprocessed data present in the timeslot box 610 at stage 620.

In the example shown, the timeslot box 610 begins to process the data of the first data instance and proceeds to stage 630. At stage 630, the timeslot 610 is in a collecting with processing state. Also at stage 630, a second data instance 635 is received at the timeslot box 610, the timeslot box 610 has completed processing the first data instance and stores a zero value for the version number associated the first data instance, and the timeslot box 610 stores the data from the second data instance with a version number value of −1. A box cleaning function 645 has been run between stage 620 and stage 630, but does not remove any data since no data is expired. In the example shown, the timeslot box 610 has been tagged “dirty” at stage 630 since there is unprocessed data present in the timeslot box 610 at stage 630.

Once processing of the data of the first data instance 625 is complete, the timeslot box 610 proceeds to stage 640. At stage 640 the timeslot box 610 is in a collecting state and the data of the first instance 625 is processed and ready to be reported with a version number of 0. The data from the second data instance 635 has not yet been processed and has a version number −1. The version number −1 in such embodiments indicates the associated data is not yet processed. In the example shown, the timeslot box 610 has been tagged “dirty” at stage 640 since there is unprocessed data present in the timeslot box 610 at stage 640.

Once processing of the data from the second data instance 635 begins, the timeslot box proceeds to stage 650. At stage 650, the version number associated with the data of the first data instance 625 remains 0. The version number associated with the second data instance 635 is incremented to 1. In this example, the version number is incremented from −1 to 0 and from 0 to 1, although other version number increments can be used. In the example shown, the timeslot box 610 has been tagged “dirty” at stage 650 since there is unprocessed data present in the timeslot box 610 at stage 650. A box cleaning function 645 has been run between stage 640 and stage 650. The box cleaning function 645 removes the data associated with the first data instance 625 since that data has been reported.

Once reporting and processing of the data associated with the second data instance 635 is also complete, the timeslot box 610 can proceed to stage 660. At stage 660 the timeslot box 610 in in a collecting state. The data associated with the first data instance 625 and the data associated with the second data instance 635 has been reported so the timeslot 610 can be placed in a collecting state again. The timeslot box 610 has been tagged “non-dirty” at stage 660 since there is no data present in the timeslot box 610 at stage 660 that has not been processed.

From stage 660 an instance of the box cleaning function 645 can be run and the timeslot 610 proceeds to stage 670. In stage 670, the box cleaning function 645 has removed the data associated with the second data instance 635 since the data has been reported. Also in stage 670, the timeslot 610 is marked expired since all data associated with the timeslot has been collected, processed, and reported.

The box cleaner can be run again on the timeslot box 610 at stage 670. At stage 680, the box cleaning function 645 has been run on the timeslot box 610 to clear the data of the timeslot box. Also in stage 680, the timeslot box 610 is marked expired. From stage 680, the box cleaner 645 can be run again on the timeslot box 610. In some embodiments, the box cleaner 645 may destroy or annihilate the timeslot box 610 after stage 680.

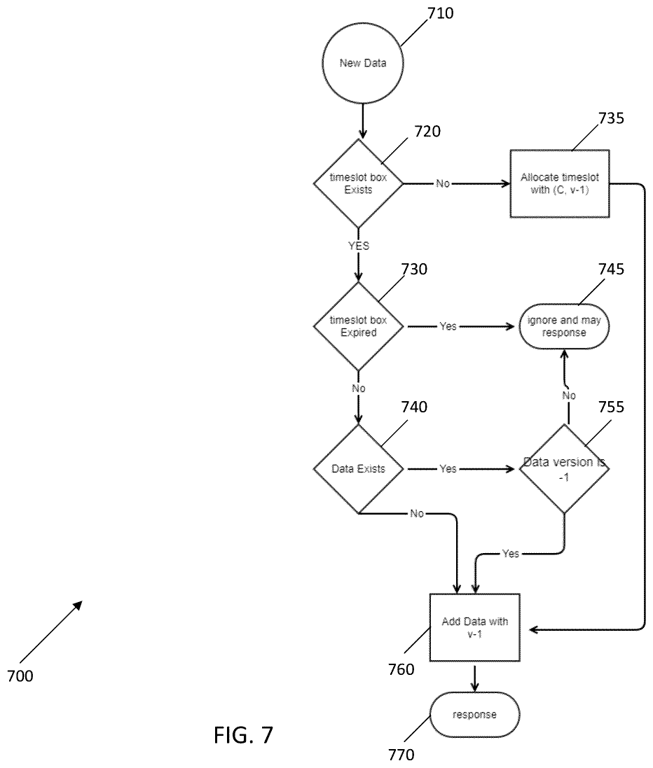

FIG. 7 illustrates a data collecting workflow 700, according to embodiments. In various embodiments, the data collecting workflow 700 can be run concurrently by multiple threads, processes, replicas, or nodes. For example, a local manager node can report data periodically to an entitlement service. In some cases a gRPC or other remote procedure call framework connection is used.

The data collecting workflow 700 begins at starting stage 710 where new data is received. From starting stage 710 where the new data is received, the workflow 700 can proceed to decision block 720.

If a timeslot box exists, the workflow 700 can proceed from decision block 720 to decision block 730. If a timeslot box does not exist, the workflow 700 can proceed from decision block 720 to stage 735 where the workflow allocates a timeslot. In some embodiments, the allocated timeslot is allocated in a collecting state and has a version number of −1. From stage 735 where the workflow 700 allocates a timeslot, the workflow 700 may proceed to stage 760 where data is added to the timeslot. In embodiments, the data added can be assigned a version number of −1. It is anticipated that various version control techniques known in the art may be applied.

At decision block 730, if the timeslot box is expired, the workflow 700 may proceed to ending stage 745 where the new data is ignored and a response may be generated.

At decision block 730, if the timeslot box is not expired, the workflow 700 may proceed to decision block 740.

At decision block 740 if data exists in the timeslot, the workflow can proceed to decision block 755. At decision block 740 if data does not exist in the timeslot the workflow can proceed to stage 760. At decision block 755 if the data version number is −1, the workflow may proceed to ending stage 745.

From stage 760 where the data is added to the timeslot box, the workflow 700 may proceed to ending stage 770 where a response may be received and the workflow ends. For example, the workflow may end after receiving a confirmation or response.

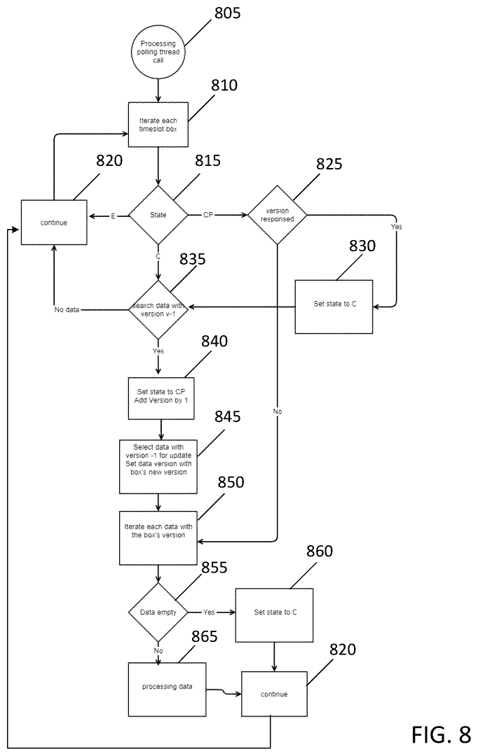

FIG. 8 illustrates a data processing workflow 800, according to embodiments. In various embodiments, the workflow 800 is run on one leader in a local manager cluster. For example, a particular timeslot box can be iterated at a local manager that is a leader of a local manager cluster. A single local manager can serve as a leader.

In the example shown, the workflow 800 begins at starting stage 805 where a processing polling thread call is made. For example, a timeslot box having data that needs to be processed will make a processing polling thread call to obtain a processing thread for the data. From stage 805 where a processing polling thread call is made, the workflow 800 may proceed to stage 810 where an iteration for each timeslot box is initiated. For example, when a data element in a timeslot box completes processing, for the next data element to be processed, a thread call is made. Each timeslot box can be iterated in such a way from a data element to the next. In the case that no additional data is to be processed, an iteration can include, for example, a change in state of the timeslot box.

From stage 810 where the timeslot box iterations are initiated, the workflow 800 can proceed to decision block 815 where a state of the timeslot box is determined.

If the state of the timeslot box at decision block 815 is expired, the workflow 800 can proceed to stage 820 where the workflow 800 begins to continue iterating each timeslot box. From stage 820 where the workflow begins to continue to iterate each timeslot box, the workflow 800 can return to stage 820 where a next iteration for each timeslot box is initiated.

If the state of the timeslot box at decision block 815 is collecting with processing, the workflow 800 can proceed to decision block 825 where it is determined whether the version is responsed. If the version is not responded to at decision block 825, the workflow 800 can proceed to stage 850 where the data of the timeslot box is iterated with the box's version number. For example, if data for a version number is still processing, a response confirming completion of processing will not have been received for the data. The data may then be iterated for the version number until a response is received.

If the version is responded to at decision block 825, the workflow 800 can proceed to stage 830 where a state of the timeslot box is set to collecting. For example, if a response has been received for the highest version number of the data, then processing has been completed and the timeslot box can be set to a collecting state. From stage 830 where the state of the timeslot box is set to collecting, the workflow 800 may proceed to decision block 835 where a search for data with a version of −1 is performed.

If no data with a version number of −1 is found at decision block 835, the workflow 800 can proceed to stage 820 where the workflow 800 begins to continue iterating each timeslot box. If data with a version number of −1 is found at decision block 835, the workflow 800 can proceed to stage 840 where the state of the timeslot box is set to collecting with processing and the version number of the timeslot box is incremented by one.

From stage 840 where the state of the timeslot box is set to collecting with processing and the version number of the timeslot box is incremented by one, the workflow 800 can proceed to stage 845 where data in the timeslot box having version number −1 is selected for update and where the data version of −1 is updated to the timeslot box's version number (which may have been incremented at stage 840).

From stage 845 where data in the timeslot box having version number −1 is selected for update and where the data version of −1 is updated to the timeslot box's version number, the workflow 800 may proceed to stage 850 where the data of the timeslot box is iterated with the box's version number.

From stage 850 where the data of the timeslot box is iterated with the box's version number, the workflow 800 may proceed to decision block 855 where it is determined whether the timeslot box is empty or still has data being processed.

If the data is empty or has been reported at decision block 855, or the timeslot box is empty of data, the workflow can proceed to stage 860 where a state of the timeslot box is set to collecting. From stage 860 where a state of the timeslot box is set to collecting, the workflow 800 can proceed to stage 820 where the workflow 800 begins to continue iterating each timeslot box.

If the data is not empty at decision block 855, or the timeslot box is still processing data, the workflow can proceed to stage 865 where processing of data continues. From stage 865 where processing of data continues, the workflow 800 can proceed to stage 820 where the workflow 800 begins to continue iterating each timeslot box.

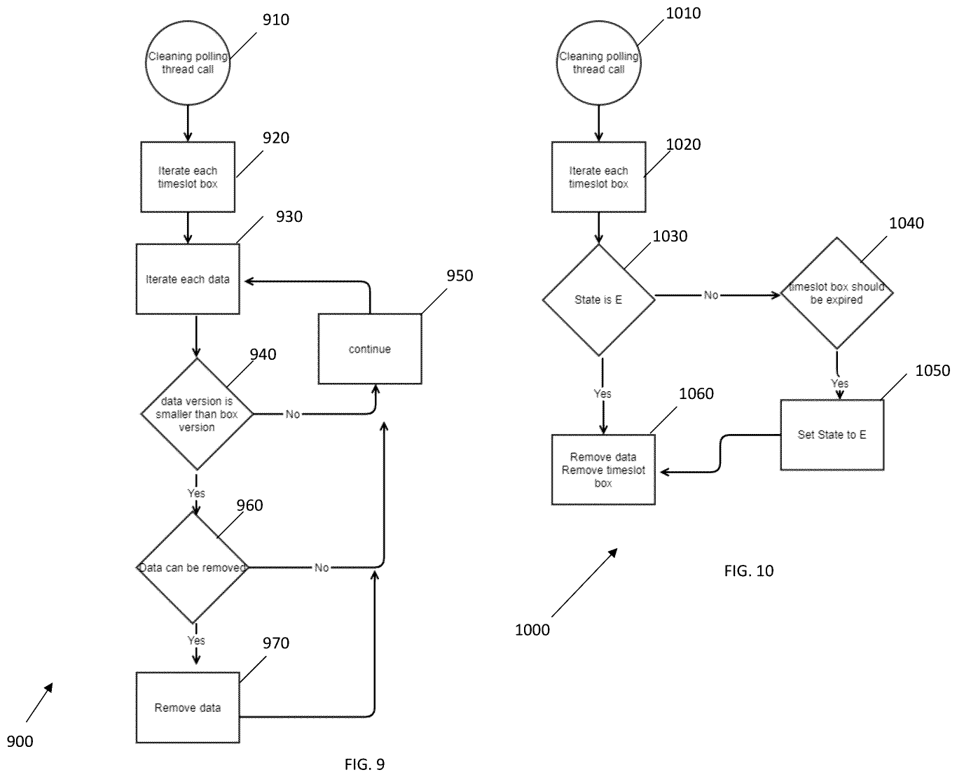

FIG. 9 illustrates a data cleaning workflow 900, according to embodiments. In some embodiments, the data cleaning workflow 900 can be run concurrently or in a separate thread at a leader node of a local manager cluster. In such embodiments, only one node needs to perform the data cleaning. In some embodiments, cleaning is initiated in a temporal workflow after data is reported or after an aggregation and/or reporting workflow is done. Data cleaning frequency may be flexible in this way and can be called every time one aggregation or reporting operation is done. In some embodiments, after aggregation, data is removed but a recorded data version number is kept at the timeslot box for deduplication and incremental update support.

As shown, the workflow 900 can begin at starting block 910 where a call to a cleaning polling thread is made. From block 910 where a call to a cleaning polling thread is made, the workflow 900 can proceed to stage 920 where an iteration of each timeslot box begins.

From stage 920 where an iteration of each timeslot box is initiated, the workflow 900 can proceed to stage 930 where, for each timeslot box, an iteration of each data element in the timeslot box begins.

From stage 930 where, for each timeslot box, an iteration of each data element in the timeslot box begins, the workflow 900 may proceed to decision block 940 where it is determined whether the data version is smaller than the version number of the timeslot box.

If the data version is not smaller than the timeslot box version number value at decision block 940, the workflow 900 can proceed to stage 950 where the workflow 900 begins to continue to iterate each data. From stage 950 where the workflow 900 begins to continue to iterate each data, the workflow 900 can proceed to stage 930 where for each timeslot box, an iteration of each data element in the timeslot box begins.

If the data version is smaller than the timeslot box version number value at decision block 940, the workflow 900 can proceed to decision block 960 where the workflow 900 determines whether data can be removed.

If data cannot be removed at the decision block 960, the workflow 900 may proceed to stage 950 where the workflow 900 begins to continue to iterate each data.

If data can be removed at the decision block 960, the workflow 900 may proceed to stage 970 where the data is removed. From stage 970 where the data is removed, the workflow 900 may proceed to stage 950 where the workflow 900 begins to continue to iterate each data.

FIG. 10 illustrates a data cleaning workflow 1000, according to embodiments. In some embodiments, the data cleaning workflow 1000 can be run concurrently or in a separate thread at a leader node of a local manager cluster.

As shown, the workflow 1000 can begin at starting block 1010 where a call to a cleaning polling thread is made. From block 1010 where a call to a cleaning polling thread is made, the workflow 1000 can proceed to stage 1020 where an iteration of each timeslot box begins.

From stage 1020 where an iteration of each timeslot box is initiated, the workflow 1000 can proceed to decision block 1030 where it is determined whether the state of the timeslot box is expired.

If it is determined at decision block 1030 that the state of the timeslot box is not expired, the workflow 1000 may proceed to decision box 1040 where it is determined whether the timeslot box should be expired.

If it is determined at decision block 1030 that the state of the timeslot box is expired, the workflow 1000 may proceed to conclude at stage 1060 where the data from the timeslot box is removed and/or the timeslot box is removed. In some embodiments, the data and timeslot box are removed at once, in some embodiments, the data is removed, and then the timeslot box is annihilated.

If it is determined at decision box 1040 that the timeslot box should be expired, the workflow 1000 may proceed to stage 1050 where the state of the timeslot box is set to expired. From stage 1050 where the state of the timeslot box is set to expired, the workflow 1000 may proceed to conclude at stage 1060 where the data from the timeslot box is removed and/or the timeslot box is removed.

If it is determined at decision box 1040 that the timeslot box should not be expired, the workflow 1000 may conclude, as no cleaning of expired data or timeslots is needed in this case.

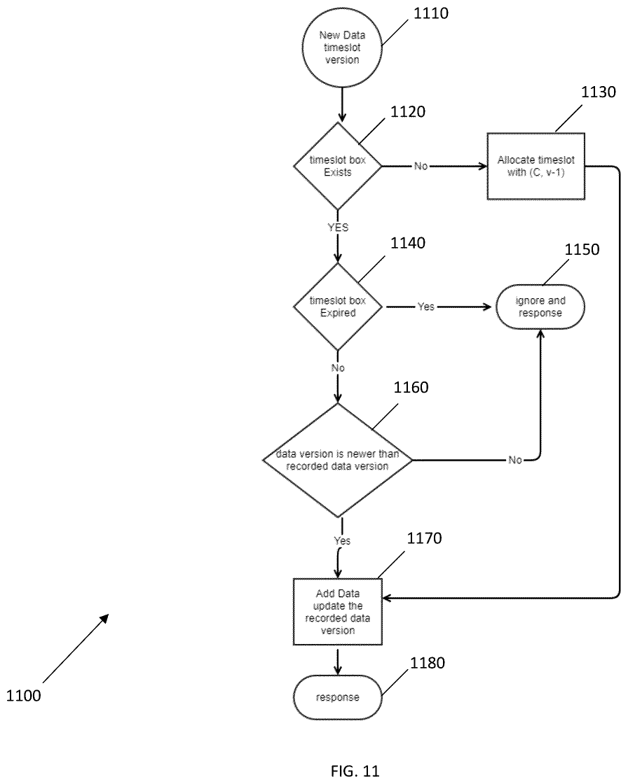

FIG. 11 illustrates a data collection workflow 1100 from a local manager, according to embodiments. As shown, the data collection workflow 1100 begins at starting block 1110 where new data is received. In various embodiments, the new data has a timestamp and/or version number associated therewith. The timestamp can be used to identify a corresponding timeslot box into which the new data item should be received.

From starting block 1110 where new data is received, the workflow 1100 may proceed to decision block 1120 where it is determined whether a timeslot box exists. For example, it may be determined whether a timeslot box corresponding to the timestamp of the new data exists.

If it is determined at decision block 1120 that the timeslot box does not exist, the workflow 1100 may proceed to stage 1130 where a new timeslot is allocated. For example, a timeslot may be allocated in a collecting state and with version number −1. From stage 1130 where the new timeslot is allocated, the workflow 1100 may proceed to stage 1170 where the data is added to the timeslot box and the data version of the timeslot box is updated.

If it is determined at decision block 1120 that the timeslot box does exist, the workflow 1100 may proceed to decision block 1140 where it is determined whether the timeslot box is expired.

If it is determined at decision block 1140 that the timeslot box is expired, the workflow 1100 may proceed to conclude at terminating block 1150 where the new data is ignored and a response is sent. For example, since the timeslot box is expired, the data is not received or processed by the timeslot box. Also for example, a response is provided so that the data may be resent when a corresponding timeslot box is available or allocated.

If it is determined at decision block 1140 that the timeslot box is not expired, the workflow 1100 may proceed to decision block 1160 where it is determined whether the data version is newer than the recorded data version.

If it is determined at decision block 1160 that the data version is not newer than the recorded data version, then the workflow 1100 may proceed to conclude at terminating block 1150 where the data is ignored and a response is sent.

If it is determined at decision block 1160 that the data version is newer than the recorded data version, the workflow 1100 may proceed to stage 1170 where the data is added to the timeslot box and the data version of the timeslot box is updated. For example, the data version value for the timeslot box may be incremented for each data element. In some embodiments a timestamp value for the data element may also be used.

From stage 1170 where the data is added to the timeslot box and the data version of the timeslot box is updated, the workflow 1100 may proceed to conclude at stage 1180 where a response is generated confirming that the data has been added to the timeslot box and/or that the version of the timeslot box has been successfully updated.

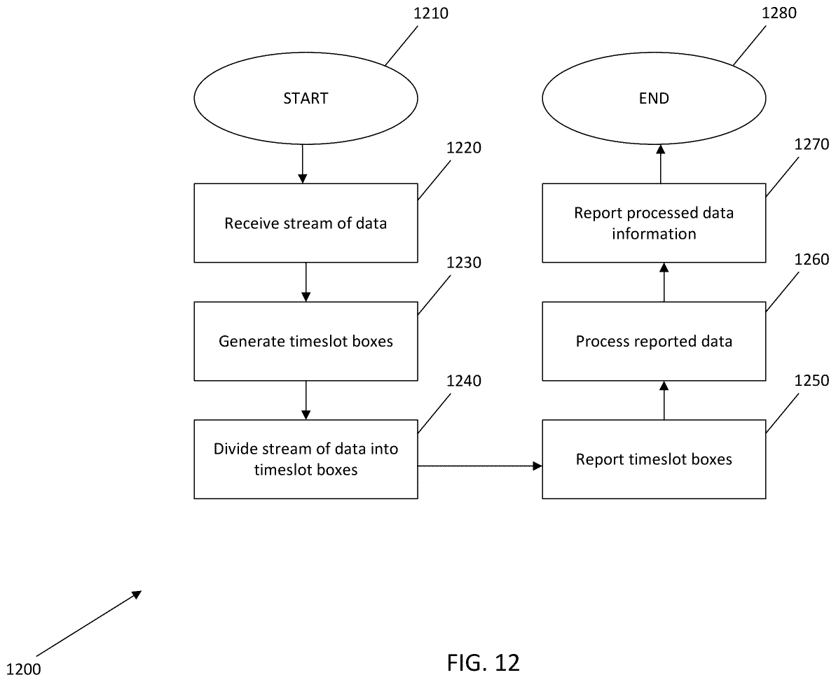

FIG. 12 is a flowchart of a method 1200 for reporting data usage information for a computing system, according to embodiments. As shown, the method 1200 begins at starting stage 1210 and proceeds to stage 1220 where the computing system receives a stream of data. For example, a computing system including one or more of a cloud service portal, an entitlement service, and one or more local manager clusters can receive a stream of data. The stream of data can be from a host device using services for which data usage may be monitored.

From stage 1220 where the computing system receives a stream of data, the method 1200 may proceed to stage 1230 where the computing system generates timeslot boxes. For example, timeslot boxes corresponding to time ranges in which data elements are sorted by an associated normalized time stamp for each data element. The timeslots can be initially generated to be in a collecting state.

From stage 1230 where the computing system generates timeslot boxes, the method 1200 may proceed to stage 1240 where the computing system divides a stream of data into timeslot boxes. For example, streams of data can be divided into timeslot boxes based on an associated time and normalizing time difference for each data element of the data stream. The example timeslot boxes are state-based and versioned controlled.

From stage 1240 where the computing system divides a stream of data into timeslot boxes, the method 1200 may proceed to stage 1250 where the computing system reports the timeslot boxes. For example, local manager clusters may report the timeslot boxes hourly, or more or less often, to an entitlement service.

From stage 1250 where the computing system reports the timeslot boxes, the method 1200 may proceed to stage 1260 where the computing system processes the reported data. For example, a replica generated by an entitlement service can receive data from local manager clusters and process the data to determine cost associated with the data, or other metadata about the data.

From stage 1260 where the computing system processes the reported data, the method 1200 may proceed to stage 1270 where the computing system reports processed data information. For example, an amount of data usage or an associated cost can be reported. In some cases, an entitlement service reports the processed data to a cloud service portal. From stage 1270 where the computing system reports processed data information, the method 1200 can conclude at ending stage 1280.

### Additional Considerations

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for reporting data usage information, the method comprising:
receiving a stream of data including data usage information from one or more components at a local manager cluster;
generating, at the local manager cluster, one or more timeslot boxes, wherein each timeslot box of the timeslot boxes comprises a time range, a timeslot box version number, and a timeslot box state;
dividing the stream of data into the one or more timeslot boxes based on one or more timeslot values and one or more timeslot difference values for the stream of data;
reporting, by the local manager cluster to an entitlement service, the stream of data divided into the one or more timeslot boxes based on corresponding timeslot box states of the timeslot boxes;
processing, by the entitlement service, the stream of data divided into the one or more timeslot boxes to determine processed data usage information; and
reporting the processed data usage information.

2. The method of claim 1, wherein the timeslot box state comprises a selection from: collecting, collecting with processing, or expired.

3. The method of claim 1, further comprising deleting data from a timeslot box of the one or more timeslot boxes after the data is reported.

4. The method of claim 1, further comprising removing an expired timeslot box.

5. The method of claim 1, further comprising incrementing a first timeslot box version number of a first timeslot box upon completion of processing of a data element received by the first timeslot box.

6. The method of claim 1, further comprising changing a state of a first timeslot box from collecting to collecting with processing upon initiating processing of a data element at the first timeslot box and changing the state of the first timeslot box from collecting with processing to expired upon reporting of a last data element at the first timeslot box.

7. The method of claim 1, wherein the timeslot values for the stream of data comprises a timeslot corresponding to a timestamp of a data element, and the one or more timeslot difference values for the stream of data correspond to a processing time delay of the data element.

8. A non-transitory computer-readable medium comprising instructions that, when executed by one or more processors of a computing system, cause the computing system to perform operations for reporting data usage, the operations comprising:
receiving a stream of data including data usage information from one or more components at a local manager cluster;
generating, at the local manager cluster, one or more timeslot boxes, the timeslot boxes comprising a time range, a timeslot box version number, and a timeslot box state;
dividing the stream of data into the one or more timeslot boxes based on one or more timeslot values and one or more timeslot difference values for the stream of data;
reporting, by the local manager cluster to an entitlement service, the stream of data divided into the one or more timeslot boxes based on corresponding timeslot box states of the timeslot boxes;
processing, by the entitlement service, the stream of data divided into the one or more timeslot boxes to determine processed data usage information; and
reporting the processed data usage information.

9. The non-transitory computer-readable medium of claim 8, wherein the timeslot box state comprises a selection from: collecting, collecting with processing, and expired.

10. The non-transitory computer-readable medium of claim 8, wherein the operations further comprise deleting data from a timeslot box of the one or more timeslot boxes after the data is reported.

11. The non-transitory computer-readable medium of claim 8, wherein the operations further comprise removing an expired timeslot box.

12. The non-transitory computer-readable medium of claim 8, wherein the operations further comprise incrementing a first timeslot box version number of a first timeslot box upon completion of processing of a data element received by the first timeslot box.

13. The non-transitory computer-readable medium of claim 8, wherein the operations further comprise changing a state of a first timeslot box from collecting to collecting with processing upon initiating processing of a data element at the first timeslot box and changing the state of the first timeslot box from collecting with processing to expired upon reporting of a last data element at the first timeslot box.

14. The non-transitory computer-readable medium of claim 8, wherein the timeslot values for the stream of data comprises a timeslot corresponding to a timestamp of a data element, and the one or more timeslot difference values for the stream of data correspond to a processing time delay of the data element.

15. A system comprising:
one or more processors; and
at least one memory, the one or more processors and the at least one memory configured to cause the system to:
receive a stream of data including data usage information from one or more components at a local manager cluster;
generate, at the local manager cluster, one or more timeslot boxes, the timeslot boxes comprising a time range, a timeslot box version number, and a timeslot box state;
divide the stream of data into the one or more timeslot boxes based on one or more timeslot values and one or more timeslot difference values for the stream of data;
report, by the local manager cluster to an entitlement service, the stream of data divided into the one or more timeslot boxes based on corresponding timeslot box states of the timeslot boxes;
process, by the entitlement service, the stream of data divided into the one or more timeslot boxes to determine processed data usage information; and
report the processed data usage information.

16. The system of claim 15, wherein the timeslot box state comprises a selection from: collecting, collecting with processing, and expired.

17. The system of claim 15, wherein the one or more processors and the at least one memory are further configured to cause the system to delete data from a timeslot box of the one or more timeslot boxes after the data is reported or remove an expired timeslot box.

18. The system of claim 15, wherein the one or more processors and the at least one memory are further configured to cause the system to increment a first timeslot box version number of a first timeslot box upon completion of processing of a data element received by the first timeslot box.

19. The system of claim 15, wherein the one or more processors and the at least one memory are further configured to cause the system to change a state of a first timeslot box from collecting to collecting with processing upon initiating processing of a data element at the first timeslot box and change the state of the first timeslot box from collecting with processing to expired upon reporting of a last data element at the first timeslot box.

20. The system of claim 15, wherein the timeslot values for the stream of data comprises a timeslot corresponding to a timestamp of a data element, and the one or more timeslot difference values for the stream of data correspond to a processing time delay of the data element.
